(19) United States
(12) Patent Application Publication
(10) Pub. No.: US 2016/0360841 A1
(43) Pub. Date: Dec. 15, 2016

(54) UMBRELLA HANDLE OR UMBRELLA TAIL HAVING ULTRAVIOLET INTENSITY SENSING FUNCTION

(71) Applicants: Ching Chang Ho, Taichuang (TW); Ai Hui HUANG, Changhua Hsien (TW)

(72) Inventor: Ching Chang HO, Taichung (TW)

(21) Appl. No.: 15/009,088

(22) Filed: Jan. 28, 2016

(30) Foreign Application Priority Data
Jun. 9, 2015 (CN) 201520391618.5

(51) Int. Cl. A45B 9/02; G01J 1/42

(52) U.S. Cl. CPC A45B 9/02; G01J 1/429; A45B 2009/002

(57) ABSTRACT

An umbrella handle or umbrella tail having ultraviolet intensity sensing function includes an umbrella handle or an umbrella tail, the interior of the umbrella handle or the umbrella tail is installed with a printed circuit board and a power module supplying electric power to the printed circuit board, the printed circuit board is installed with a ultraviolet sensor, a data processing unit for processing signals sensed by the ultraviolet sensor and a wireless transmission module, the ultraviolet sensor is electrically connected to an input end of the data processing unit, and an output end of the data processing unit is electrically connected to the wireless transmission module. Accordingly, the present invention is provided with advantages of simple in structure, convenient in operation and capable of sensing the ultraviolet intensity.

### FIELD OF THE INVENTION

The present invention relates to an umbrella handle or an umbrella tail, especially to an umbrella handle or an umbrella tail having ultraviolet intensity sensing function.

### BACKGROUND OF THE INVENTION

Ultraviolet is defined as the lights with wavelength between 100 nm to 400 nm in the sunlight. With respect to different wavelengths, the ultraviolet can be categorized to UVA (wavelength 320 nm to 400 nm, long wavelength), UVB (wavelength 280 nm to 320 nm, middle wavelength) and UVC (wavelength 100 nm to 280 nm, short wavelength); the ultraviolet can be used for sterilizing, but too much ultraviolet entering the human body will cause skin cancer, this is because large amount of free radicals would be generated when ultraviolet radiate on the skin which causes the peroxidation of the cell membrane (plasma membrane), so melanocytes generate more melanin, and the melanin would be upwardly distributed to skin cuticle and generate black spots, so the ultraviolet can be seemed as the biggest threats for skin wrinkling, aging, loosening and the generation of black spots. Wherein, UVB has the most severe carcinogenicity with 1,000 times of capacity to cause skin to have irritations and sunburns comparing to UVA.

However, ultraviolet is almost everywhere in our lives, and the ultraviolet intensity would change in different weather conditions, wherein summer has the strongest ultraviolet radiation, because we cannot see the ultraviolet with our bare eyes, the actual ultraviolet intensity could not be known, especially for those who often have to go to outdoors, with the lack of information about the ultraviolet intensity, people would be in a passive status and actions for blocking the ultraviolet would not be effective processed.

### SUMMARY OF THE INVENTION

For overcoming the above-mentioned disadvantages, one primary objective of the present invention is to provide an umbrella handle or umbrella tail having ultraviolet intensity sensing function, which had advantages of simple in structure and convenient in operation.

Accordingly, one technical solution provided by the present invention is to provide an umbrella handle or umbrella tail having ultraviolet intensity sensing function, which includes an umbrella handle or an umbrella tail, the interior of the umbrella handle or the umbrella tail is installed with a printed circuit board and a power module supplying electric power to the printed circuit board, the printed circuit board is installed with a ultraviolet sensor, a data processing unit for processing signals sensed by the ultraviolet sensor and a wireless transmission module, the ultraviolet sensor is electrically connected to an input end of the data processing unit, and an output end of the data processing unit is electrically connected to the wireless transmission module.

Preferably, according to the present invention, the interior of the umbrella handle or the umbrella tail is installed with a temperature sensor, and the temperature sensor is electrically connected to the input end of the data processing unit.

Preferably, according to the present invention, a switch is provided for controlling the conduction or termination of the connection between the printed circuit board and the power module.

Preferably, according to the present invention, the power module includes a wire, a button cell and electrode discs at two ends of the button cell, one end of the wire is connected the electrode discs and the other end thereof is connected to the printed circuit board.

Preferably, according to the present invention, the wireless transmission module 33 is a Bluetooth.

According to the present invention, the interior of the umbrella handle or the umbrella tail is installed with the printed circuit board and the power module supplying electric power to the printed circuit board, the printed circuit board is installed with the ultraviolet sensor, the data processing unit for processing signals sensed by the ultraviolet sensor and the wireless transmission module, the ultraviolet sensor is electrically connected to the input end of the data processing unit, and the output end of the data processing unit is electrically connected to the wireless transmission module. As such, when the ultraviolet intensity in the current environment is desired to be sensed, the power source is conducted for allowing the ultraviolet sensor to sense the ultraviolet in the current environment, and the sensed signals are transmitted to the data processing unit, after the signals are processed by the data processing unit, the signals are transmitted to a display terminal through the wireless transmission module, thus a user can sense the ultraviolet intensity in the current environment at any place and any time, and he/she can make a corresponding decision for blocking the ultraviolet according to the sensing result; accordingly, the present invention is provided with advantages of simple in structure and convenient in operation.

### BRIEF DESCRIPTION OF THE DRAWINGS

FIG. 1 is a schematic view showing the whole structure of an umbrella;

FIG. 2 is a longitudinal cross sectional view showing a first embodiment of the present invention;

FIG. 3 is a schematic view showing the connecting structure of each component according to the present invention;

FIG. 4 is a schematic view showing the structure of the printed circuit board shown in FIG. 2;

FIG. 5 is a top view showing the button cell shown in FIG. 2;

FIG. 6 is a front view showing the button cell shown in FIGS. 2; and

FIG. 7 is a longitudinal cross sectional view showing a second embodiment of the present invention.

### DETAILED DESCRIPTION OF THE PREFERRED EMBODIMENT

In the embodiments provided by the present invention, what shall be addressed is that the terms for indicating orientations or location relations such as “center”, “top”, “bottom”, “front”, “rear”, “left” and “right” are based on the orientations or the location relations illustrated in the drawings, the above-mentioned terms are merely used for fully disclosing the present invention and shall not be seemed as any indication or hint for that the devices and units have to be in a specific orientation, or be structured or operated in a specific direction, so the above-mentioned terms shall not be seems as the limitations to the scope of the present invention. Moreover, the terms “first” and “second” are merely used for illustration, and shall not be seemed as any indication or hint for the relative importance.

In the embodiments provided by the present invention, what shall be addressed is that, unless a specific regulation or limitation is provided, the terms such as “install”, “connect” and “combine” shall be provided with wider comprehensions, for example can be fixedly connected and also can be detachably connected or integrally connected; can be mechanically connected and also can be electrically connected; can be directly connected or also can be indirectly connected through a medium or can be the interiors of two component being communicated. For the skilled people in the art, the above-mentioned terms shall be reasonably comprehended and understood. Moreover, in the embodiments provided by the present invention, unless additional illustrations are provided, the terms “plural” and “several” shall refer to two or more than two.

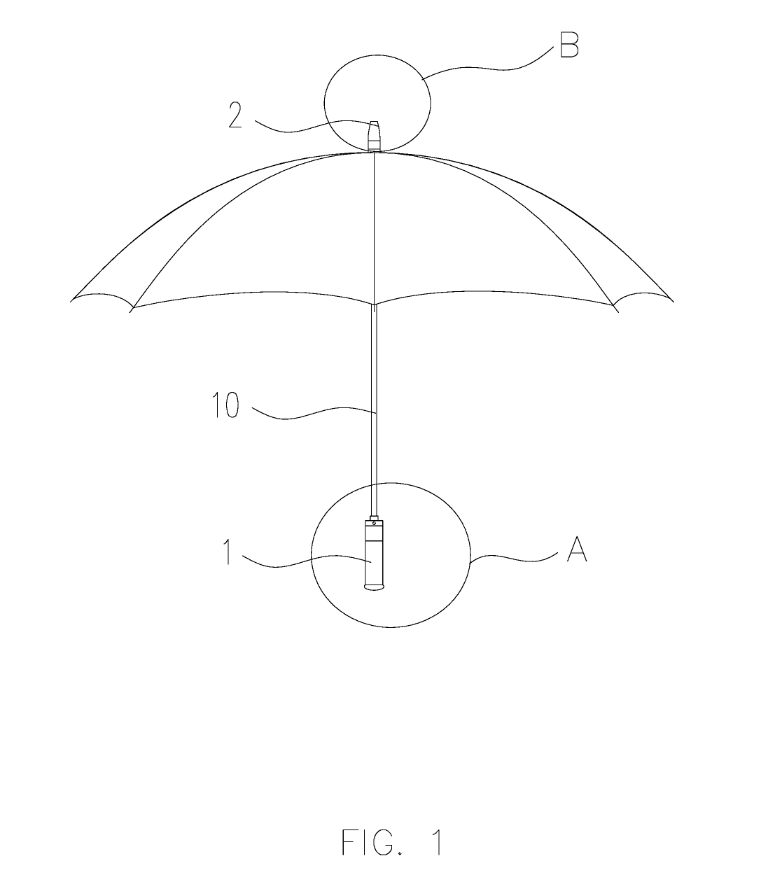

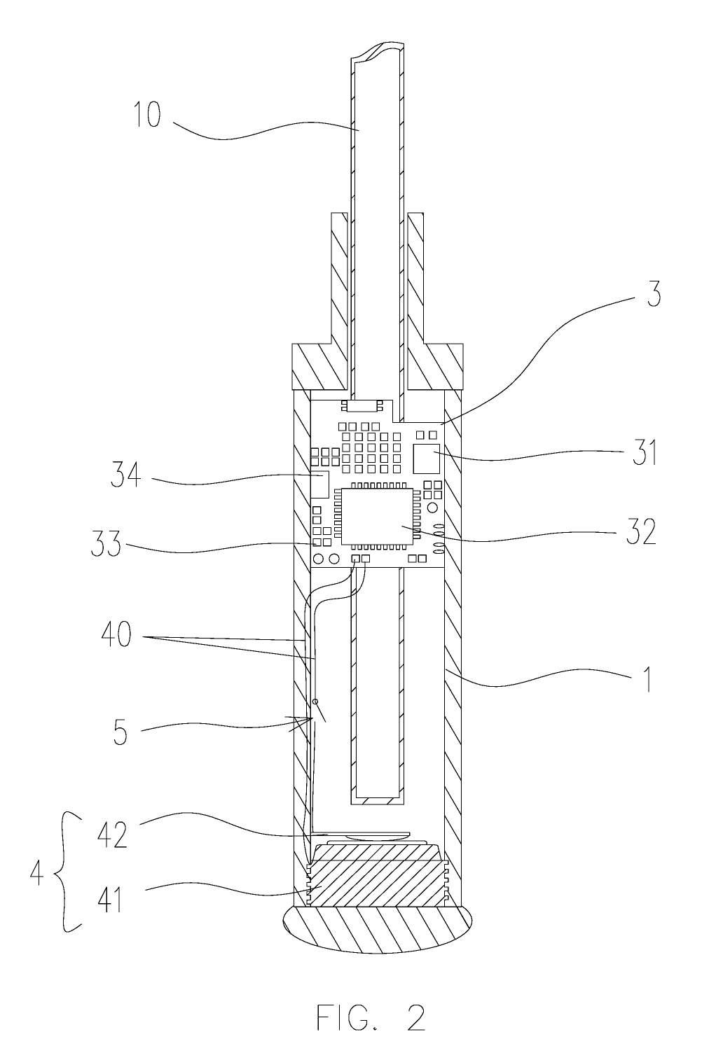

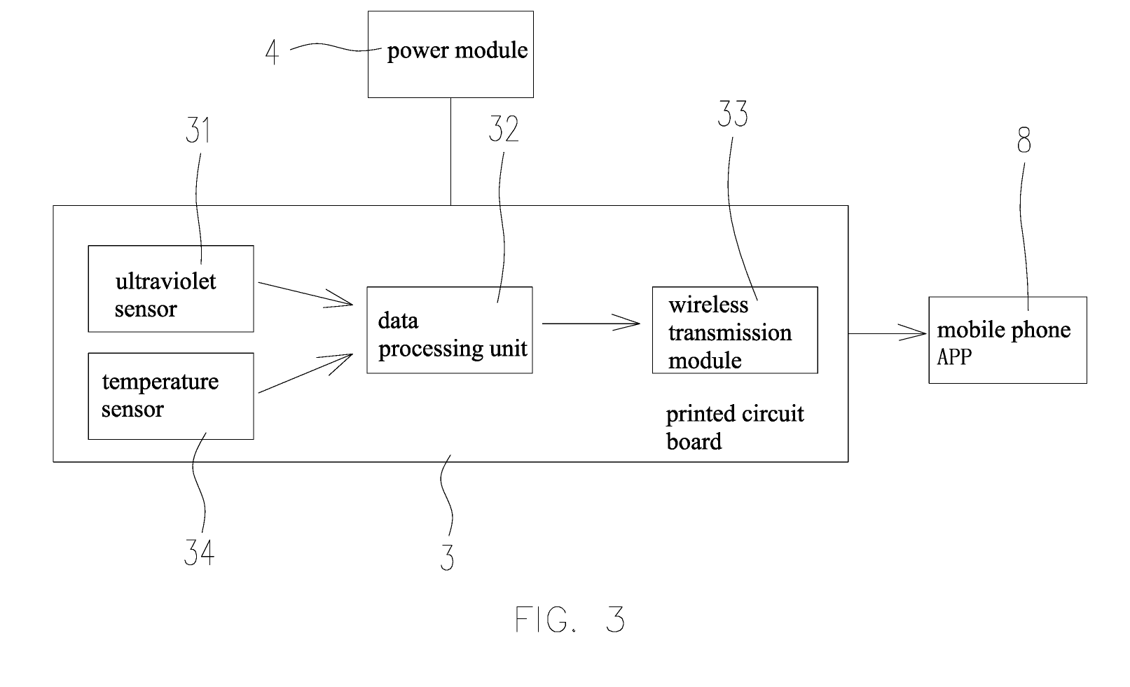

Please refer from FIG. 1 to FIG. 6, which disclose a first embodiment for an umbrella handle or umbrella tail having ultraviolet intensity sensing function, and please refer from FIG. 1 to FIG. 3, wherein FIG. 2 is a cross sectional view of an enlarged A section of FIG. 1. According this embodiment, the present invention provides an umbrella handle or umbrella tail having ultraviolet intensity sensing function, which includes an umbrella handle 1, the interior of the umbrella handle 1 is installed with a printed circuit board 3 and a power module 4 supplying electric power to the printed circuit board 3, the printed circuit board 3 is installed with a ultraviolet sensor 31, a data processing unit 32 for processing signals sensed by the ultraviolet sensor 31 and a wireless transmission module 33, the ultraviolet sensor 31 is electrically connected to an input end of the data processing unit 32, an output end of the data processing unit 32 is electrically connected to the wireless transmission module 33; according to the present invention, an umbrella stick 10 is inserted in the umbrella handle 1, when the ultraviolet intensity in the current environment is desired to be sensed, the power source is conducted for allowing the ultraviolet sensor 31 to sense the ultraviolet in the current environment, and the sensed signals are transmitted to the data processing unit 32, after the signals are processed by the data processing unit 32, the signals are transmitted to a display terminal through the wireless transmission module 33, according to the present invention, the display terminal is a mobile phone application program (APP) 8, thus the ultraviolet intensity in the current environment is able to be obtained through watching the data provided by the mobile phone application program (APP) 8. Because an umbrella is easy to be carried around, a user can sense the ultraviolet intensity in the current environment at any place and any time, and he/she can make a corresponding decision for blocking the ultraviolet according to the sensing result, thus the whole operation process is very convenient.

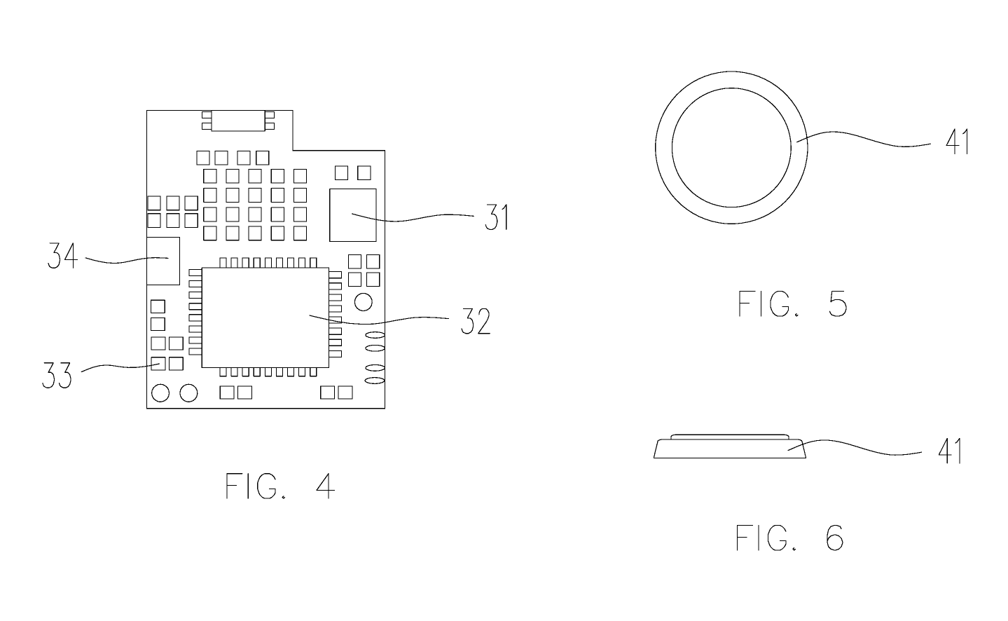

Moreover, the present invention can also provide a temperature sensing function, the interior of the umbrella handle 1 is installed with a temperature sensor 34 (as shown in FIG. 4), the temperature sensor 34 is electrically connected to the input end of the data processing unit 32, when the umbrella handle 1 starts to process the operation of sensing ultraviolet intensity, the temperature sensor 34 can also be operated for sensing the temperature in the current environment, and the sensed signals are transmitted to the data processing unit 32, after the signal are processed by the data processing unit 32, the signals are transmitted to the display terminal through the wireless transmission module 33, so the temperature information is able to be displayed on the display terminals, and the user can directly know the temperature in the current environment through watching the information shown in the display terminal.

According to the present invention, for controlling the operating of sensing the ultraviolet intensity, the present invention further includes a switch 5 for controlling the conduction or termination of the connection between the printed circuit board 3 and the power module 4, when the operation of sensing the ultraviolet intensity is desired to be processed, the switch 5 is switched on for enabling the printed circuit board 3 and the power module 4 to be conducted, so the umbrella handle 1 is able to sense the ultraviolet intensity in the current environment; when the operation of sensing the ultraviolet intensity is no longer desired to be processed, the switch 5 is switched off for terminating the connection between the printed circuit board 3 and the power module 4, so the umbrella handle 1 stops the operation of sensing the ultraviolet intensity in the current environment.

According to the present invention, the power module 4 preferably includes a wire 40, a button cell 41 (as shown in FIG. 5 and FIG. 6) and electrode discs 42 at two ends of the button cell 41, one end of the wire 40 is connected the electrode discs 42 and the other end thereof is connected to the printed circuit board 3. In addition, according to the present invention, the wireless transmission module 33 is preferably to be a Bluetooth.

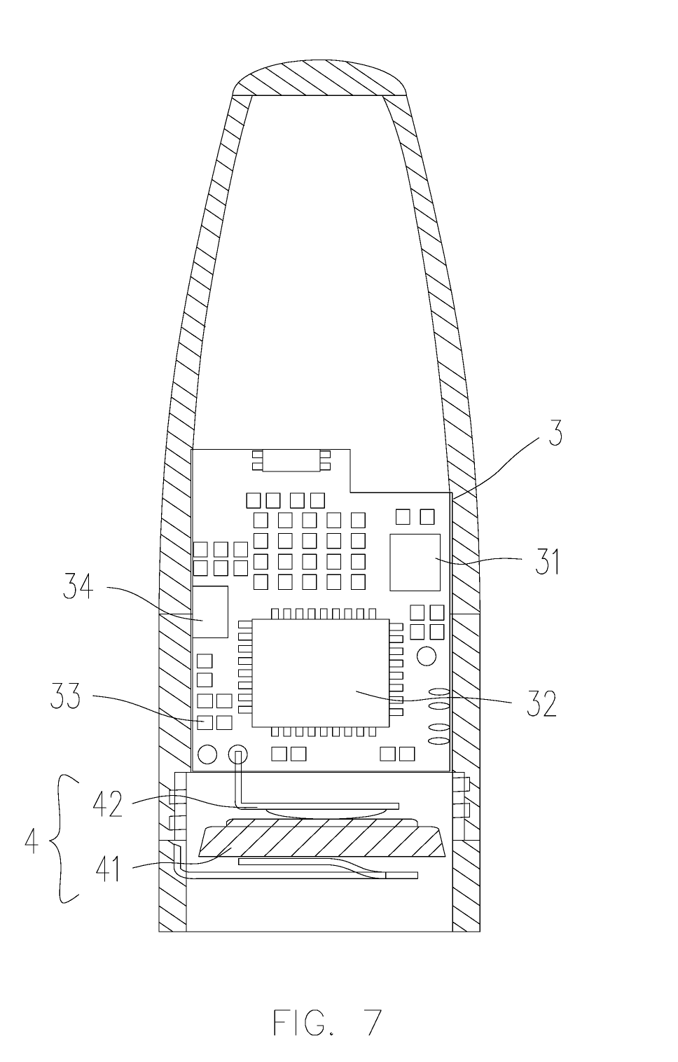

The present invention also discloses a second embodiment (as show in FIG. 7, which is a cross sectional view of an enlarged B section of FIG. 1), the second embodiment is substantially the same as the first embodiment, and the difference is that the umbrella tail of an umbrella is provided with the ultraviolet intensity sensing function.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. An umbrella handle or umbrella tail having ultraviolet intensity sensing function, including an umbrella handle (1) or an umbrella tail (2), wherein the interior of the umbrella handle (1) or the umbrella tail (2) being installed with a printed circuit board (3) and a power module (4) supplying electric power to the printed circuit board (3), the printed circuit board (3) being installed with a ultraviolet sensor (31), a data processing unit (32) for processing signals sensed by the ultraviolet sensor (31) and a wireless transmission module (33), the ultraviolet sensor (31) being electrically connected to an input end of the data processing unit (32), and an output end of the data processing unit (32) being electrically connected to the wireless transmission module (33).

2. The umbrella handle or umbrella tail having ultraviolet intensity sensing function as claimed in claim 1, wherein the interior of the umbrella handle (1) or the umbrella tail (2) is installed with a temperature sensor (34), and the temperature sensor (34) is electrically connected to the input end of the data processing unit (32).

3. The umbrella handle or umbrella tail having ultraviolet intensity sensing function as claimed in claim 2, wherein a switch (5) is provided for controlling the conduction or termination of the connection between the printed circuit board (3) and the power module (4).

4. The umbrella handle or umbrella tail having ultraviolet intensity sensing function as claimed in claim 1, wherein the power module (4) includes a wire (40), a button cell (41) and electrode discs (42) at two ends of the button cell (41), one end of the wire (40) is connected the electrode discs (42) and the other end thereof is connected to the printed circuit board (3).

5. The umbrella handle or umbrella tail having ultraviolet intensity sensing function as claimed in claim 1, wherein the wireless transmission module (33) is a Bluetooth.

6. The umbrella handle or umbrella tail having ultraviolet intensity sensing function as claimed in claim 2, wherein the power module (4) includes a wire (40), a button cell (41) and electrode discs (42) at two ends of the button cell (41), one end of the wire (40) is connected the electrode discs (42) and the other end thereof is connected to the printed circuit board (3).

7. The umbrella handle or umbrella tail having ultraviolet intensity sensing function as claimed in claim 3, wherein the power module (4) includes a wire (40), a button cell (41) and electrode discs (42) at two ends of the button cell (41), one end of the wire (40) is connected the electrode discs (42) and the other end thereof is connected to the printed circuit board (3).

8. The umbrella handle or umbrella tail having ultraviolet intensity sensing function as claimed in claim 2, wherein the wireless transmission module (33) is a Bluetooth.

9. The umbrella handle or umbrella tail having ultraviolet intensity sensing function as claimed in claim 3, wherein the wireless transmission module (33) is a Bluetooth.
